(19) United States
(12) Patent Application Publication
(10) Pub. No.: US 2002/0111848 A1
(43) Pub. Date: Aug. 15, 2002

(54) Aggregation of services on network portals

(76) Inventor: Craig R. White, Eagle, ID (US)

Correspondence Address: HEWLETT-PACKARD COMPANY, Intellectual Property Administration, P.O. Box 272400, Fort Collins, CO, 80527-2400, US

(21) Appl. No.: 09/781,654

(22) Filed: Feb. 12, 2001

(51) Int. Cl. G06F 17/60

(52) U.S. Cl. 705/10

(57) ABSTRACT

A method and system of dynamically constructing a network portal includes accessing a dynamic service provider database that includes a listing of service providers that have self-selected their inclusion into the dynamic service provider database. Next, keyword-service link are displayed on the network portal along with the service providers listed in the dynamic service provider database. Upon activation of a keyword-service link by the user, the network portal displays service providers from the dynamic service provider database that offer services matching the selected keyword on the network portal. Once a service provider is selected by the user, a direct connection between the user and the service provider is established to permit the services to be provided.

### FIELD OF THE INVENTION

The present invention relates to network portals, and more particularly, to a method and system for network portals to present a dynamically constructed aggregation of service providers.

### BACKGROUND OF THE INVENTION

Internet portals act as an Internet clearinghouse to link consumers to Internet sites that have information or services desired by the consumer. Internet portals, such as Yahoo®, make use of the Internet more convenient and less intimidating by allowing a user to select a subject of interest and obtain a link to relevant, high-quality Internet sites for that subject. This feature dramatically diminishes the trial and error process of searching for and evaluating Internet sites from the complete universe of Internet sites in the World Wide Web.

Internet portals follow a business model that permits companies and/or Internet sites to act as sponsors to the Internet portal by advertising on Web pages displayed by the Internet portal. Internet portals also create revenue by making contractual arrangements with an Internet site to be an exclusive or nearly exclusive provider of a particular type of information or service on the Internet portal. Accordingly, when a consumer requests a particular type of information at the Internet portal, the Internet portal links the consumer to a predetermined Internet-site service provider. For example, many Internet portals and premium Internet service providers (ISP) include mapping information services. When a consumer activates a request for mapping information/services, the Internet portal links the consumer's Internet browser to a predetermined mapping service Internet site. The relationship between the Internet portal and the mapping information internet site is typically a fee-for-display contractual arrangement in which the internet site is charged a fee by the Internet portal so that a link to the internet site is displayed on the Internet portal as the exclusive service provider for a given category of service.

The good news about this conventional model of an Internet portal is that it reduces the need for the consumer to perform trial and error searching for a suitable Internet site offering a desired information or service. Unfortunately, the bad news is that the link between the Internet portal and the particular service (e.g., map service) is fixed or static. Accordingly, aside from user-initiated searching, the Internet site selected by the Internet portal is the only service provider available through the portal to the user for providing that particular type or category of service.

In addition, the Internet portal may exert some leverage and control over what a particular internet site offers to consumers through the Internet portal since the portal controls whether are not consumers are directly linked to the particular Internet site. Accordingly, as portals grow in stature and in economic influence on the World Wide Internet, Internet sites that offer consumer-oriented services may retain less and less bargaining power and see less exposure to consumers on the Internet, unless they can attain a fee-for-display contract with an Internet portal.

### SUMMARY OF THE INVENTION

A method of the present invention of dynamically constructing an Internet portal includes accessing a dynamic service provider database that includes a listing of service providers that have self-selected their inclusion into the dynamic service provider database. Next, keyword-service link are displayed on the Internet portal along with the service providers listed in the dynamic service provider database. Upon activation of a keyword-service link by the user, the Internet portal displays service providers from the dynamic service provider database that offer services matching the selected keyword on the Internet portal. Once a service provider is selected by the user, a direct connection between the user and the service provider is established to permit the services to be provided.

### BRIEF DESCRIPTION OF THE DRAWINGS

FIG. 1 is a schematic illustration of a method and system of the present invention for dynamic aggregating service-providing Internet sites on an Internet portal.

FIG. 2 is a block diagram of a home page for a dynamic Internet portal of the method and system of the present invention.

FIG. 3 is a block diagram of a shopping service page for a dynamic Internet portal of the method and system of the present invention.

FIG. 4 is a flow diagram of a user accessing a service provider on an Internet portal in a method and system of the present invention.

FIG. 5 is a flow diagram of a service provider handling service requests from a user in a method and system of the present invention.

FIG. 6 is a block diagram of a service document representing a service provider in a method and system of the present invention.

FIG. 7 is a flow diagram of an Internet portal aggregating service-providing internet-site in a method and system of the present invention.

FIG. 8 is a flow diagram of a service provider offering services through dynamic Internet portal in a method and system of the present invention.

FIG. 9 is a block diagram of a digital workshop portal in a method and system of the present invention.

FIG. 10 is a block diagram of a dynamic software suite portal in a method and system of the present invention.

FIG. 11 is a block diagram of a trip planning portal in a method and system of the present invention.

### DESCRIPTION OF THE PREFERRED EMBODIMENTS

In the following detailed description of the preferred embodiments, reference is made to the accompanying drawings which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

Components of the present invention may be implemented in hardware via a microprocessor, programmable logic, or state machine, in firmware, or in software within a given device. In one aspect, at least a portion of the software programming is web-based and written in HTML and JAVA programming languages, including links to graphical user interfaces, such as via windows-based operating system. The components may communicate via a network using a communication bus protocol. For example, the present invention may or may not use a TCP/IP protocol suite for data transport. Other programming languages and communication bus protocols suitable for use with the present invention will become apparent to those skilled in the art after reading the present application. Components of the present invention may reside in software on one or more computer-readable mediums. The term computer-readable mediums as used herein is defined to include any kind of memory, volatile or non-volatile, such as floppy disks, hard disks, CD-ROMs, flash memory, read-only memory (ROM), and random access memory (RAM).

An Internet portal displays links to service providers to permit a user to conveniently find and connect to a service-providing Internet site that offers a particular type or category of service. A method and system of the present invention permits an Internet portal to operate dynamically by including a display of links to service providers that are taken from a dynamic database of service providers. These service providers self select their inclusion into the dynamic service provider database. The display of the service providers on the internet portal may or may not be based on a fee-for-display contractual basis between the internet portal and each service provider, or may or may not be based on a fee-for-service contractual arrangement between the user and the internet portal. This Internet portal of the method and system of the present invention is in contrast to conventional Internet portals which include only exclusive fee-for-display relationships between service providers and Internet portals.

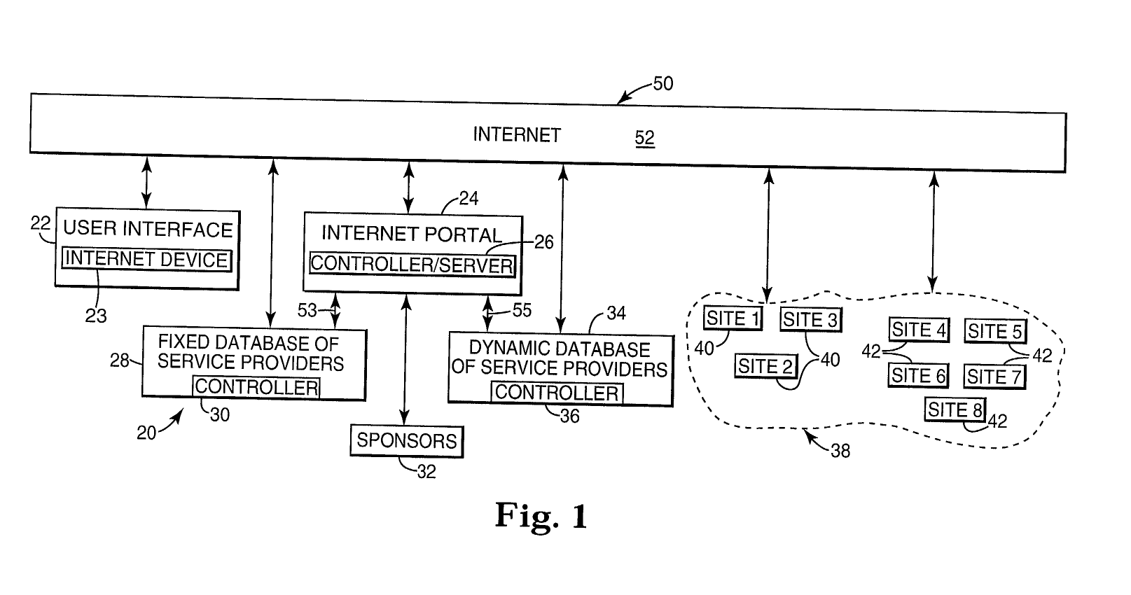

A dynamic network portal system and method according to the present invention is illustrated generally at 20 in FIG. 1. System 20 includes user interface 22 on internet-capable device 23, internet portal 24 with controller 26, fixed service provider database 28 with controller 30, sponsors 32, and dynamic service provider database 34 with controller 36. System 20 further includes unbounded universe of network (e.g., Internet sites) sites 38 including service-providing Internet sites (herein “service providers”) 40 listed in fixed service provider database 28 and service-providing Internet sites (herein “service providers”) 42 listed in dynamic service provider database 34.

System 20 also further comprises network communication link 50. Network communication link 50, as used herein, includes an internet communication link (e.g., the Internet), an intranet communication link, or similar high-speed communication link. In one preferred embodiment, network communication link 50 includes an Internet communication link 52. Iternet communication link 52 permits communication between user interface 22, Internet portal 24, fixed service provider database 28, dynamic service provider database 34, sponsors 32, as well as service provider 40, 42.

Internet portal 24, including Internet portal controller 26, can be implemented in hardware via a microprocessor, programmable logic device, or state machine, and firmware, or in software within a given device. In one aspect, at least a portion of the software programming is written in Java programming language, and each of the main components communicate via Internet communication link 52 using a communication bus protocol. For example, the present invention optionally can use a TCP/IP protocol suite for data transport. Other programming languages in communication bus protocols suitable for use with dynamic Internet portal system 20 will be apparent to those skilled in the art.

Internet portal controller 26 includes hardware, software, firmware or combination of these. In one preferred embodiment Internet portal controller 26 includes a computer server or other microprocessor based system capable of performing a sequence and logic operations. In addition, Internet portal controller 26 can include a microprocessor embedded systems/appliance incorporating tailored appliance hardware and/or dedicated single purpose hardware. Controllers 30 and 36 for fixed service provider database 28 and dynamic service provider database 34, respectively, are configured substantially similar to Internet portal controller 26.

As illustrated in FIG. 1, user interface 22 on Internet-capable device 23 permits user access to system 20. User interface 22 is preferably an Internet browser such as internet Explorer® or Netscape Navigator®. Internet device 23 includes, for example an input device such as a keyboard and/or mouse and a display device such as a monitor, as is well known in the art. Accordingly Internet device 23 may include a desktop computer, notebook computer, personal digital assistants (PDA), smart mobile phone or other device known in the art, such as Internet appliances, for conducting Internet communications.

In one aspect, user interface 22 runs on an operating system which can support one or more applications. The operating system is stored in memory and executes on a processor. The operating system is preferably a multi-tasking operating system which allows simultaneous execution of multiple applications, although aspects of this invention may be implemented using a single-tasking operating system. The operating system employs a graphical user interface windowing environment which presents the applications or documents in specially delineated areas of the display screen called “windows”. Each window has its own adjustable boundaries which allow the user to enlarge or shrink the application or document relative to the display screen. Each window can act independently, including its own menu, toolbar, pointers, and other controls, as if it were a virtual display device. Other software tools may be employed via the window, such as a spreadsheet for collecting data. One preferred operating system is a Windows® brand operating system sold by Microsoft Corporation. However, other operating systems which provide windowing environments may be employed, such as those available from Apple Corporation or IBM. Alternatively, a non-windowing environment may be employed.

Internet portal 24, as supported by controller 26, is any internet site capable of being accessed via Internet communication link 52, and which provides directions and guidance to user to connect to service providers 40,42 as well as providing searching capabilities to identify and access additional internet sites within the unbounded universe of web sites 38.

Fixed service provider database 28 is operated on controller 30 and communicates with Internet portal 24 directly via link 53 or via Internet communication link 52. Fixed database 28 is a database, preferably maintained by Internet portal 24, of exclusive service providers 40 for a particular type of service. When viewed by user interface 22, Internet portal 24 displays a link to preferred service providers 40 to permit the user to conveniently access those sites 40. Using fixed service provider database 28, Internet portal 24 selectively controls the number, type, and specific service providers 40 available for linking in user interface 22. However, the user is free to invoke a general searching function to find additional service providers.

In a common example, a user viewing Internet portal 24 through user interface 22 is provided with a number of subjects or channels, such as news, entertainment, traveling, finance, sports etc. Upon selecting one of the subjects, Internet portal 24 displays links to preferred service providers 40 listed within fixed service provider database 28 that are related to the selected subject. In this manner, the user can rely upon Internet portal 24 to immediately provide a link to Internet site that carry the desired information or services. Service providers 40 primarily become part of fixed service provider database 28 through a fee-for-display contractual relationship with Internet portal 24. Alternatively, absent a contractual arrangement, service providers 40 can only become part of fixed database 28 when selected by Internet portal 24 for display. Finally, the only other way an internet site from the unbounded universe of internet sites 38 can be displayed via Internet portal 24 is when the user invokes a general searching function of Internet portal 24 to find a relevant service provider (e.g., an internet site) through trial and error searching.

Dynamic service provider database 34 is operated on controller 36 and communicates with Internet portal 24 directly via link 55 or via Internet communication link 52. Dynamic database 34 is a database maintained by Internet portal 24, or an independent third party, which governs a process by which service providers 42 can self register themselves for possible listing on Internet portal 24. In particular, rather than Internet portal 24 exclusively selecting a set of preferred service providers 40 from fixed service provider database 28 for display on Internet portal 24, dynamic database 34 permits an ever-changing universe 38 of internet sites to offer their services in dynamic service provider database 34 for ultimate display on Internet portal 24. In this model, service providers 42 that are interested in offering their services through Internet portal 24 effectively submit a bid to Internet portal 24, or a third party supervising dynamic service provider database34, to have their services offered on Internet portal 24. The bid made by the service providers includes a keyword description of the service, the price of services, and an Internet site name for accessing the service, etc. Using additional criteria such as user preferences via user interface 22, as well as keyword descriptions, Internet portal 24 retrieves from dynamic service provider database 34 those service providers 42 that match a subject listed in Internet portal 24. Links representing those keyword-matched service providers 42 are then displayed on Internet portal 24 for selection by the user. Accordingly, dynamic database 34 permits a given subject within Internet portal 24 to include a variable number and type of service providers 42 to appear as links on Internet portal 24. In contrast fixed service provider database 28 include only a fixed, static number and type of links to service providers at 40 for display as links on Internet portal 24.

Internet portal 24 can display service providers 42 for free, based on a fee-for-display contract between the service provider 42 and Internet portal 24, or based on a fee-for-service contract between the user and Internet portal 24, or some combination of these arrangements. In the fee-for-display model, Internet portal 24 may charge service provider 42 each time their link is displayed on Internet portal 24 or by some other fee system. In the fee-for-service model, internet portal 24 charges the user for a higher level of service from internet portal 24, which would include user access to dynamic service provider database 34 via internet portal 24.

Significantly, a method and system of the present invention including operation of dynamic database 34 for aggregating service providers 42 for display on internet portal 24 does not depend primarily on the financial arrangements. Rather, the primary relationship is that each time that internet portal 24 is constructed on user interface 22, links to service providers 42 that are displayed on internet portal 24 may change depending upon which service providers 42 are listed in dynamic service provider database 34 for a particular keyword or category of services at the time internet portal is constructed. This listing is not exclusively controlled by Internet portal 24. Accordingly, links on internet portal 24 as viewed by the user will likely change so that the user is not locked into viewing only the service providers 40 that have long term fee-for-display arrangements with the internet portal 24. This dynamic model of aggregating service providers 42 also can benefit internet portal 24 since newer and perhaps better service providers 42 will regularly be brought to the attention of internet portal 24.

While service provider 40,42 provides services, the term services as used in this application should also be understood to more broadly include information and/or products.

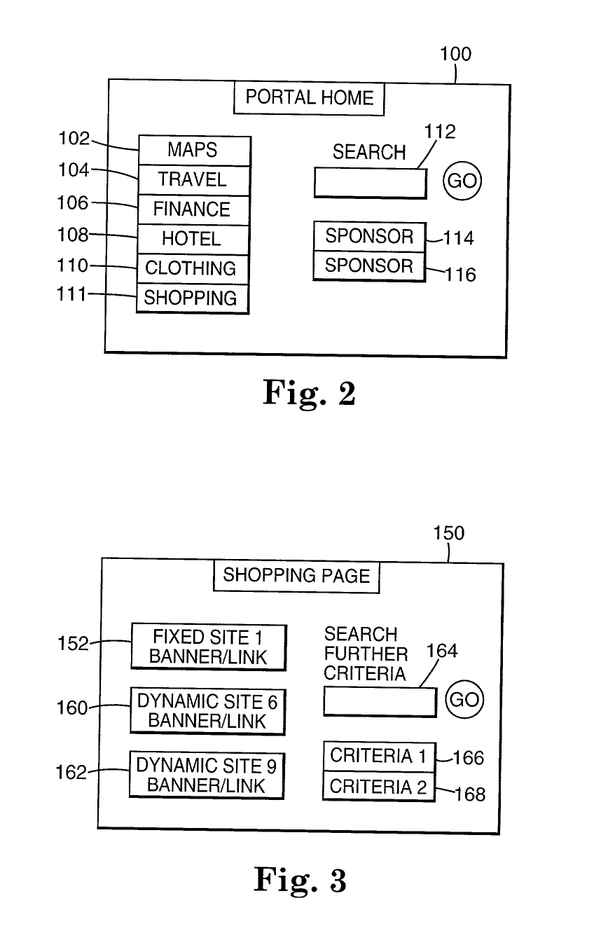

FIG. 2 illustrates home page 100 of dynamic Internet portal 24 as it appears on user interface 22. Portal home page 100 includes a variety of subject categories or channels including, but not limited to: maps 102, travel 104, finance 106, hotel 108, clothing 110, and shopping 111. Portal home page 100 also includes a search function 112 as well as advertising sponsors 114 and 116. Each subject category includes one or more links to independent service providers 40,42. Accordingly, upon selection of one of the subject categories via user interface 22, links to service providers 40,42 providing those subject-specific services or information are made available through Internet portal 24.

For example, selection of shopping category 111 on portal home page 100, results in the display of shopping page 150 on user interface 22, as shown in FIG. 3. Shopping page 150 includes links to fixed service provider 152, dynamic service providers 160,162, as well search function 164 and additional criteria 166 and 168. Fixed service provider link 152 identifies and provides a link to a predetermined service provider of shopping services. While only one fixed service provider link 152 are shown in FIG. 3, when shopping page 150 is activated, internet portal 24 displays all shopping-related internet sites listed within fixed service provider database 28, which are exclusively selected by internet portal 24.

Dynamic service provider links 160, 162 on shopping page 150 identify and provide links to service providers of shopping services that are not selected exclusively by Internet portal 24. In particular, when shopping page 150 is activated, Internet portal 24 displays all shopping-related sites listed within dynamic service provider database 34, such as links 160,162. Of course, more or less than the two links shown in FIG. 3 can be displayed.

Shopping page 150 can display one or more fixed service provider links 152 from fixed service provider database 28, one or more service provider links 160, 162 from dynamic service provider database 34, or any combination of service provider links from both fixed and dynamic databases 28, 34. Fixed service provider link 152 remains static upon each instance an activation of shopping page 150, since Internet portal 24 exclusively selects service providers for inclusion into fixed service provider database 28. On the other hand, dynamic service provider links 160,162 may change upon each activation of shopping page 150 depending upon the content of dynamic service provider database 34, since inclusion of service providers 42 within the database 34 is not exclusively controlled by Internet portal 24.

In addition, criteria functions 166,168 permit a user to select additional predetermined criteria (e.g. cost) for limiting the listing of service provider links or for eliciting more service providers from dynamic service provider database 34. Moreover, the user also can use search-further-criteria function 164 to elicit other Internet sites from dynamic service provider database 34 by designating further keyword information/criteria. In this way, the user is permitted to work are interactively with dynamic service provider database 34, via internet portal 24, to find-tune the type and number of service provider links 160,162 listed on shopping page 150 from dynamic service provider database 34.

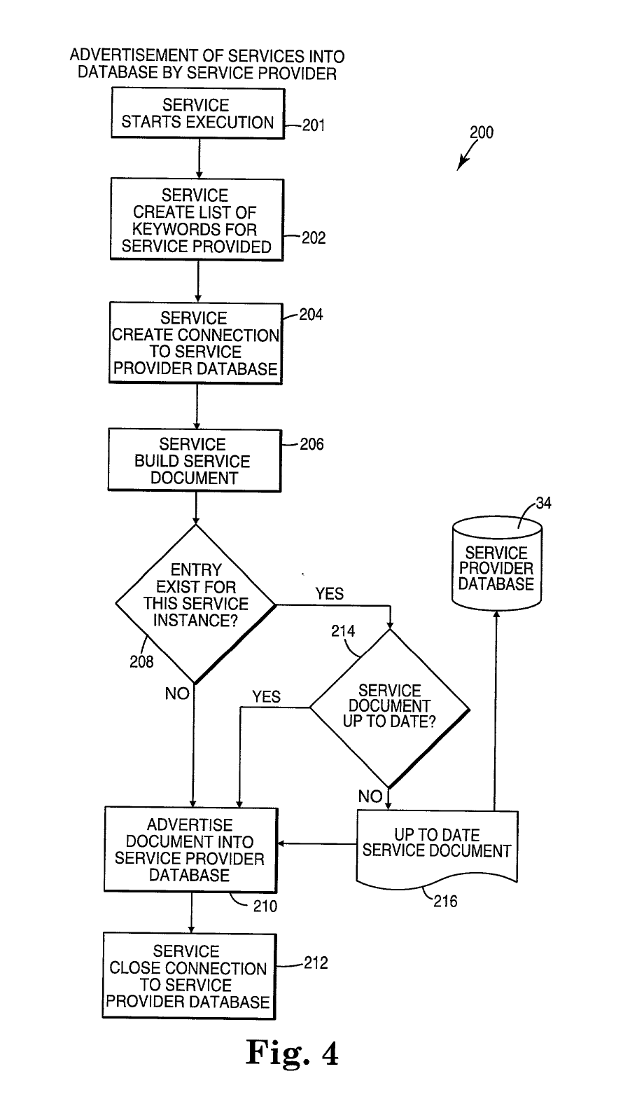

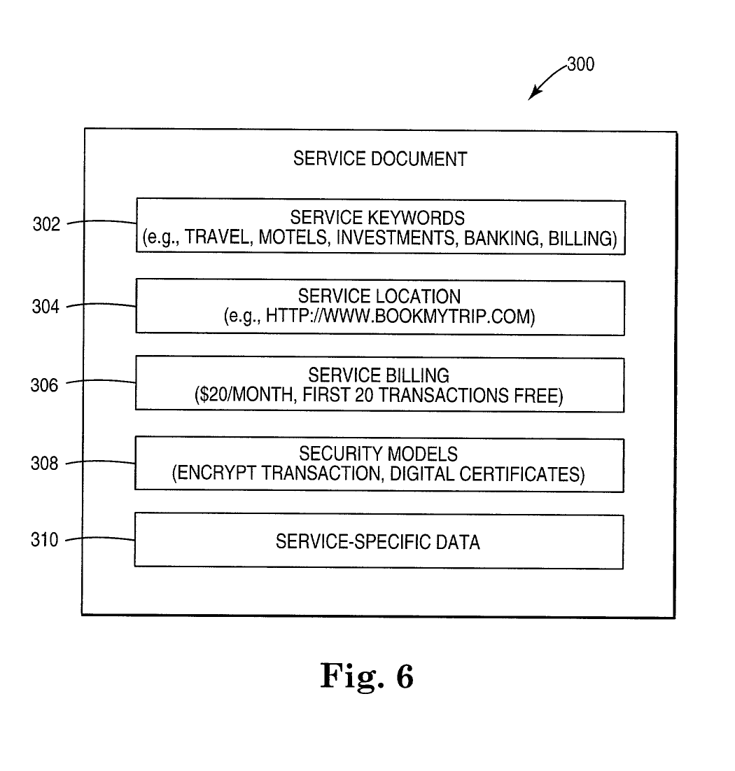

FIG. 4 is a flow diagram illustrating process 200 by which a service provider 42 is listed within dynamic service provider database 34. Once listed, service provider 42 is available to be displayed on Internet portal 24 upon a user request for a given category-specific service. In first step 201 of process 200, service provider 42 starts execution of the process. Next, service provider 42 creates a list of keywords for identifying or describing the service provided (step 202). Service provider 42 then connects to dynamic service provider database 34 (step 204) and builds service document 300 (step 206), as will be further described later in association with FIG. 6. In the next step (step 208), a query is made as to whether an entry for this particular service provider exists in dynamic service provider database 34 (step 208). If the query is answered affirmatively, then it is determined whether service document 300 representing service provider 42 is up-to-date (step 214). If service document 300 is up-to-date, service document 300 is advertised into the dynamic service provider database 34 (step 210). If service document 300 is not up-to-date, then the following step includes providing an up-to-date service document 300 (step 216). Alternatively, in step 208, if an entry does not exist for this particular service provider 42 within the dynamic database 34, then the next step includes advertising service document 300 representing service provider 42 into dynamic service provider database 34 (step 210). Finally, after advertisement of service document 300 into dynamic service provider database 34, including any necessary updating of the service document 300 (216), then service provider 42 closes connection to the dynamic service provider database 34 (step 212). Service provider 42 then awaits possible contact from a user via service provider link displayed in Internet portal 24.

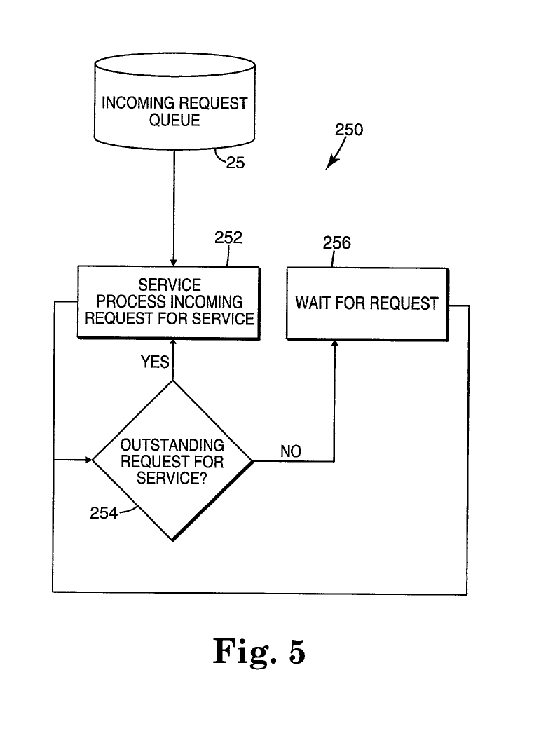

FIG. 5 is a flow diagram illustrating process 250 by which service provider 24, listed with the dynamic service provider database 34, handles a request for services. In particular, process 250 begins with providing incoming request queue (step 251) and then processing an incoming request for service (step 252). After the services are provided, a query is made on whether there is an outstanding request for services (step 254). If an outstanding request exists, then step 252 of processing an incoming request for service is repeated. Alternatively, if no outstanding request for services is made, then service provider 42 must wait for a request for services (step 256).

FIG. 6 is a block diagram illustrating service document 300, which is advertised by service provider 42 for listing into dynamic service provider database 34. Service document 300 provides a common format so that descriptive information from each service provider 42 is submittable to, and retrievable from, dynamic service provider database 34 in a uniform manner. This common format enables dynamic service provider database 34 to operate efficiently and permits Internet portal 24 and/or a user to efficiently differentiate between service providers 42.

Service document 300 includes service keywords 302, service location 304, service billing 306, security models 308, and service-specific data 310. Service keywords 302 include descriptive terms such as travel, motels, investments, banking, billing, etc. for identifying the type of service provided by service provider 42. Service location 304 generally represents an address identified on the World Wide Web, or Internet, such as a uniform resource locator (URL) for accessing service provider 42 via Internet communication link 52. Service billing 306 represents the cost charged by service provider 42 to the user, cost charged to Internet portal 24 for accessing its services, or the cost paid by service provider 42 for display of its link on internet portal 24, as well as any other financial arrangements.

Security model 308 of service document 300 represents the security method by which the service provider will communicate with Internet portal 24 and user interface 22 to provide the service. Finally, service-specific data 310 includes data which is unique to the particular service provided. This data 310 assists Internet portal 24 in selecting service provider 42 from dynamic service provider database 34 and in assigning service provider 42 to a subject category or channel within Internet portal 24. In addition data 310 assists a user in determining whether service provider 42 provides the type of service desired. For example, data 310 to be displayed automatically with each link to service provider 42, or can be listed after activation of additional search criteria 164 or criteria function 166 168 as shown in FIG. 3.

Service document 300 is built by service provider 42 in step 206 of process 200 as shown in FIG. 4. When properly updated, service document 300 is provided in step 210 of process 200 (see FIG. 4) for advertisement and listing in dynamic service provider database 34.

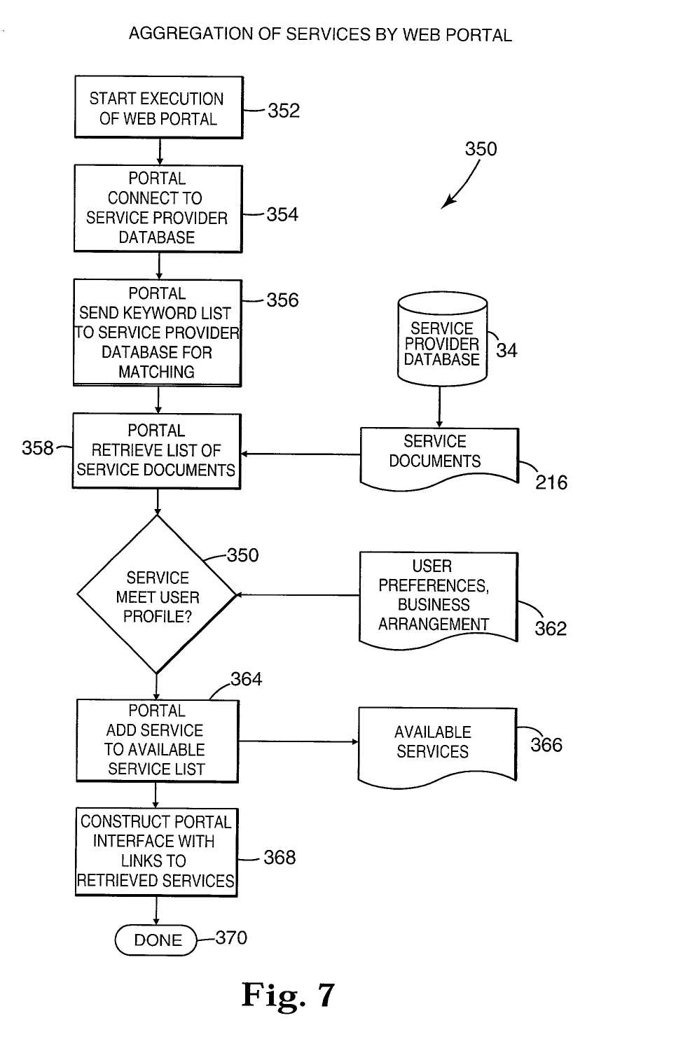

FIG. 7 is a flow diagram illustrating process 350 by which Internet portal 24 dynamically aggregates service providers 42 from dynamic service provider database 34 for display on Internet portal 24. A first step 352 of process 350 includes starting execution of Internet portal 24. Internet portal 24 then connects to dynamic service provider database 34 (step 354) and sends a list of keywords identifying types or categories of services to dynamic service provider database 34 for matching (step 356). A list of service documents 300, which respectively represent different service providers 42 that match the keyword list from Internet portal 24, is retrieved (step 358) from service documents 300 stored within dynamic service provider database 34. In step 360, each service document 300 is examined by Internet portal 24 to determine whether the advertised service and service document 300 meets a user profile. In determining whether the advertised service meets a user profile (step 362), Internet portal 24 considers business arrangements such as fee-for-service arrangements between the user and internet portal 24, user preferences for the types of services most often requested by the user, as well as discretionary content filters operated by internet portal 24. If service document 300 meets the user profile and Internet portal criteria in step 362, then Internet portal 24 adds advertisement of the particular service to the available services list (step 364) which is stored in memory as available services (step 366). Finally, Internet portal 24 constructs its display on user interface 22 to include keyword-matched links to service providers 42 that are in the available services list.

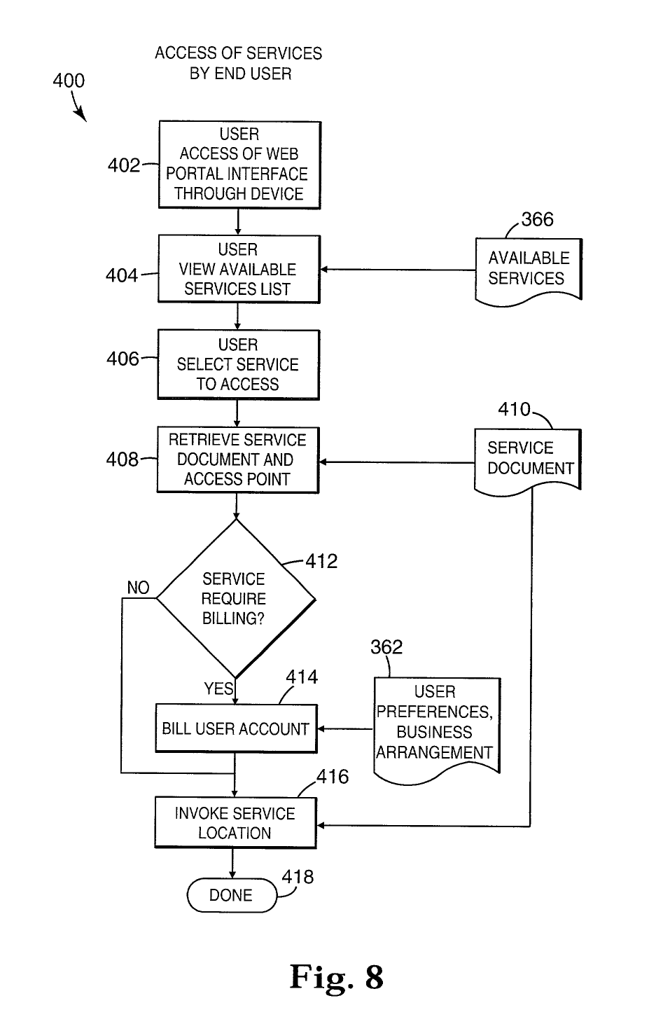

FIG. 8 is a flow diagram illustrating process 400 of a user accessing services provided through Internet portal 24. In first step (402) of process 400, the user accesses Internet portal 24 through Internet device 23. Next, the user views the available services list (step 365 from FIG. 7) which is provided through Internet portal 24 from its list of available services (step 366). After viewing the list of available services, user selects a service to access (step 406) which causes Internet portal 24 to retrieve service document 300 and access point (step 408) corresponding to the desired service. A query is then made by Internet portal 24 on whether the selected service requires billing (step 412). If no billing is required, the next step includes the user invoking the service location (i.e. Internet site link) from service document 300 (step 410) to link the end-user directly to service provider 42 offering the service (step 416).

Alternatively, if billing is required (step 412), then internet portal 24 arranges to bill an account of the user (step 414) according to user preferences and business arrangements previously arranged between the user and Internet portal 24 (step 362). After the user account is billed in step 414, the service location (e.g. URL) is invoked from service document 410 to link the end-user with service provider 42 offering the selected service (step 416). After this linking step is completed, process 400 of using internet portal 24 to match an end-user with service provider 42 is completed (step 418), temporarily terminating active involvement by internet portal 24.

Accordingly, service providers 42 are aggregated onto Internet portal 24 into dynamic manner including a self selection or bidding process in which service providers 42 first advertise their services into dynamic service provider database 34. Internet portal 24 in turn provides to users a list of all service providers 42 from dynamic service provider database 34 that satisfy subject-keyword matching, user preferences and other Internet portal 24 criteria.

The method and system of the present invention of dynamically aggregating service providers for display on Internet portal 24 preferably operates in a general purpose portal, such as Yahoo® or Juno®. Alternatively, the method and system of the present invention can be operated in a stand-alone special-purpose portal for providing a single type of service. For example, a special-purpose portal can be portal for engineers, financial services, word processing services, shopping, travel, etc.

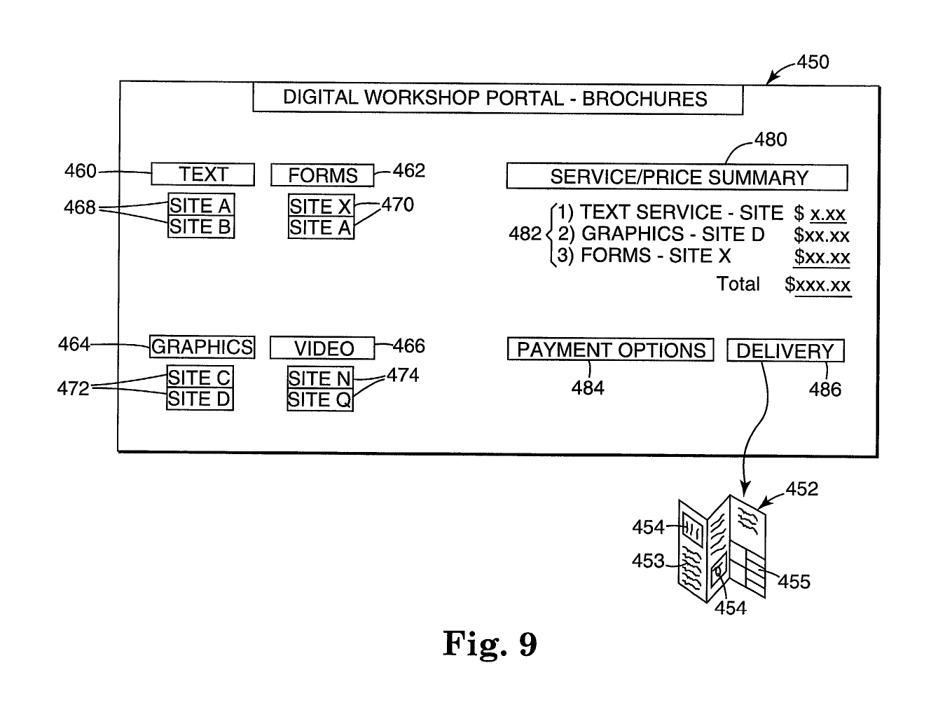

As shown in FIG. 9, a method and system of the present invention of providing a dynamic Internet portal includes a method and system of providing a digital workshop portal (DWP) 450. Digital workshop portal 450 is a portal permitting an end-user to perform or obtain software-related services or retail services, all related to a special purpose.

For example as shown in FIG. 9, digital workshop portal 450 is directed toward designing, selecting and producing brochure 452 for end-user. Brochure 452 includes text 453, graphics 454, and forms 455. Portal 450 permits a user to select different service providers 42 for obtaining text, forms, graphics and video elements for inclusion into a single brochure for mass reproduction. Accordingly, digital workshop portal 450 includes text function 460, forms function 462, graphics function 464, and video function 466.

Upon activation, text function 460 includes links to service-providing Internet sites 468 that provide or offer text services for brochures and other publications. Upon activation, forms function 462 includes links to service-providing Internet sites 470 that provide and/or offer forms for inclusion into brochures and related publications. Graphics function 464 includes links to service-providing internet sites 472 that provide and/or offer graphics images and graphics software applications for permitting insertion of graphics into brochures and related publications. Finally, video function 466 optionally includes links to service-providing Internet sites 474 that provide single video images for print publication. Alternatively, video function 466 can provide links to obtaining streaming video segments for inclusion into an e-brochure, i.e. a brochure viewable through Internet portal 24. Related functions can include ripping, format translation, and other document creation tools, as known to those skilled in the art.

Digital workshop portal 450 for brochures further includes service/prices summary function 480, which includes an itemized listing of different services with their associated prices 482. Portal 450 also includes payment options function 484 and delivery function 486. Service price summary function 480 allows the end-user to see the cost of a brochure as it is being built on a service-by-service basis. Payment function 484 permits user to direct payment to digital workshop portal 450 and/or individual service providers 42 on portal 450. In addition, based on a user account between Internet portal 24 and the user, Internet portal 24 can arrange for payment from end-user to digital workshop portal 450 and/or directly to service providers 42 used in constructing brochure 452. Delivery function 486 permits the user to select the method and date of delivery of completed brochures 452 from digital workshop portal 450.

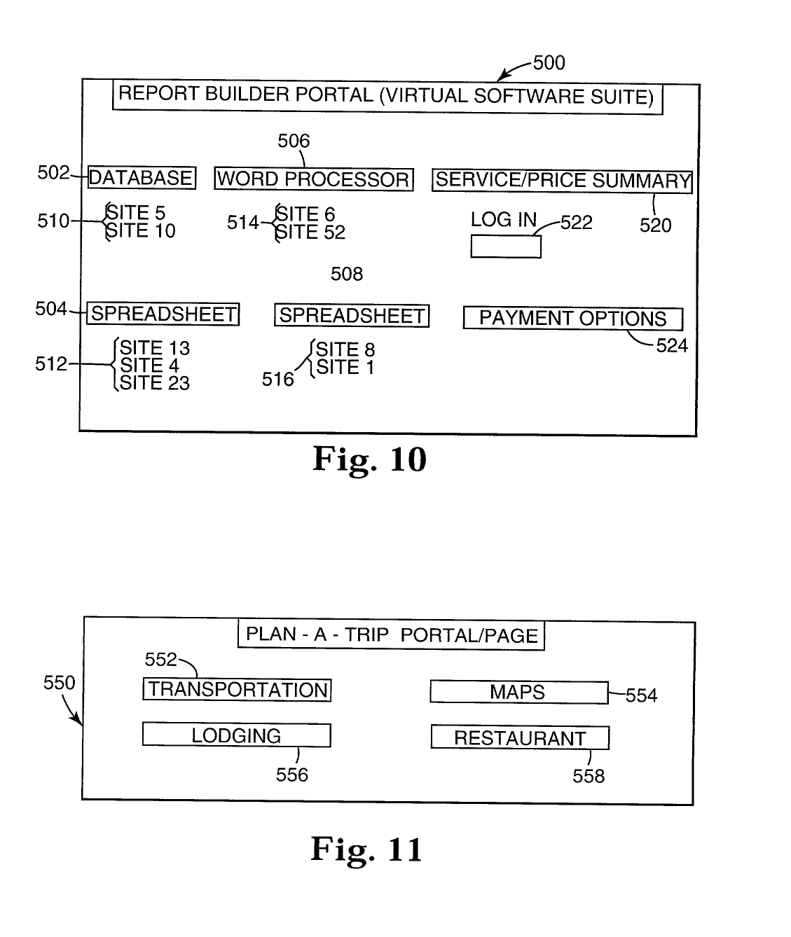

With the method and system of the present invention, a user can employ Internet portal 24 as a custom application service provider to select and construct a customized combination of application services. For example, as shown in FIG. 10, report builder portal 500 acts as a virtual software suite permitting end-user to create and use a custom grouping of software applications through Internet portal 24. In effect, portal 500 operates as an application service provider (ASP), as known to those skilled in the art, that is dynamically customizable at the discretion of the user and that is implemented by numerous different service providers 42 that participate in dynamic service provider database 34 linked to portal 500.

Report builder portal 500 includes database function 502, spreadsheet function 504, word processor function 506, publishing function 508, as well as any other necessary software functions. Each of these functions represents a software application which can be accessed by the end-user after being linked via portal 500 to a particular service provider 42 providing those software applications. Of course additional software applications can be added to report builder portal 500 either by initiation of the service provider 42 or upon request from the end-user.

Database function 502 provides links to service providers 510 offering Web-centric database software applications usable by end user via Internet link 52. Spreadsheet function 504 provides links to service providers 512 offering Web-centric spreadsheet software applications usable via Internet link 52. Word processor function 506 provides links to service providers 514 offering Web-centric word processing software applications. Finally, publishing function 508 provides links to service providers 516 offering Web-centric publishing software applications.

Services/price summary function 520 displays a listing of the description of services selected along with their pricing in a format substantially similar to that shown in FIG. 9 for digital workshop portal 450. Report builder portal 500 includes a login function 522, so that if a particular custom software suite selected by the end-user is created, it can be accessed numerous times over a predetermined period of time agreed upon between the end-user and internet portal 24 and/or between end user and portal 500 (including service providers 42 selected in the software suite). Finally, payment options function 524 allows the user to arrange payment for the selected services, in a manner substantially similar for portal 450 as described in association with FIG. 9.

In addition, end-user can select only some of the software applications from portal 500 so that the selected applications can be used with existing software applications on the user's own internet-capable device 23 such as a desktop computer. This feature allows the end-user to mix and match its own software applications with those available through Internet portal 500. This method essentially permits a user to create a virtual software e-suite by leasing, renting or purchasing a software application, or multiple software applications, which are grouped selectively by the user. Once the software suite is created by the user, login function 522 enables recall of the software suite portal 500 from memory, and permits access to the customized suite via portal 500 for as long as the particular software application has been purchased, leased, etc.

In another embodiment, a method and system of providing a dynamic e-portal of the present invention includes plan-a-trip portal 550. In this example, portal 550 includes transportation function 552, maps function 554, lodging function 556, and restaurant function 558. Upon activation of each of those respective functions, Internet portal 24 uses dynamic service provider database 34 to identify and offer one or more service providers 42 for possible selection and use by the end-user.

Finally, Internet portal 24 can include a custom aggregation page so that a user can build their own Internet page of aggregated services from dynamic service provider database 34. Alternatively, dynamic service provider database 34 can have its own internet portal allowing a user to select their own services on a service document-by-service document with user interface 22 permitting the user to build their own Web page aggregating desired service providers 42 in one or more categories of service.

Accordingly, a method and system of the present invention for dynamically aggregating service providers on an Internet portal carries numerous advantages. First, the method combines the convenience of an Internet portal in grouping Internet sites with the flexibility and control of selecting service providers other than those already selected by an Internet portal, which have a fixed, static relationship with an Internet portal. Second, the method and system allows service-providing internet sites to advertise their services in a manner that is more likely to be seen by the user and enable those internet sites to provide services to users without having a fixed, ongoing contract a relationship with an internet portal as an exclusive service provider for a category or type of service on an internet portal. Rather, service providers have the ability to price and market its services as desired for potential inclusion/purchase from an Internet portal 24 and for possible selection/purchase from a user.

While specific embodiments have been illustrated and described, herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the chemical, mechanical, electromechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A method of constructing a network portal comprising:
accessing a first service provider database that includes a listing of service providers that have self-selected their inclusion into the first service provider database; and
displaying keyword-service links on the network portal in association with the service providers from the first service provider database.

2. The method of claim 1, wherein the displaying step further comprises:
displaying a link on the network portal to at least one service provider of the first service provider database for activation by a user to connect a user interface to the service provider.

3. The method of claim 1, further comprising:
displaying at least one criteria function for permitting a user to specify further criteria for selecting a group of service providers from the first service provider database.

4. The method of claim 1, further comprising
performing the accessing step independent of exclusive control by the network portal.

5. The method of claim 1 wherein the displaying step further comprising:
displaying only keyword-service links included within a set of predetermined types of service purchased by a user in a fee-for-service contractual arrangement between the user and the network portal.

6. The method of claim 5, further comprising displaying only keyword-service links matching a set of predetermined user preferences.

7. The method of claim 1, further comprising:
accessing a second fixed service provider database that includes a listing of service providers having a fee-for-display contractual arrangement with the network portal to permit display on the network portal of a link to each of fee-for-display service providers.

8. A method of accessing network-based service providers through a user interface comprising:
accessing a network portal with a network-capable computing device;
viewing a list of available services on the network portal;
selecting a service for access by the user;
reviewing a service document displayed on the user interface that identifies a type and manner of service provided by a service provider; and
invoking a service location to connect the user interface to the service provider and to permit user access to the selected service.

9. The method of claim 8, further comprising:
arranging for fee-for-service payment of the selected services through a user account associated with the network portal and based on a predetermined contractual arrangement between the user and the network portal.

10. A method for providing a network portal comprising:
initiating construction of a network portal interface upon a user request to access the network portal;
linking the network portal to a first service provider database;
submitting type-of-service keywords displayed on the network portal to the first service provider database for matching with types of services offered by service providers listed in the first service provider database;
retrieving from the first service provider database a list of service providers that match the type-of-service keywords;
comparing each keyword-matched service provider against a set of predetermined user profile criteria; and
completing construction of the network portal interface by displaying links to keyword-matched and user-profile matched services offered by the service providers of the first service provider database.

11. The method of claim 10 wherein the comparing step further comprises:
determining whether the type and number of service providers matches the user profile criteria.

12. The method of claim 11 wherein the determining step further comprises:
selecting the number and type of service providers based upon a user subscription to a fee-for-service arrangement between the user and the network portal.

13. The method of claim 10, further comprising:
displaying on the network portal a link to a service provider selected from a second service provider database that includes a listing of service providers exclusively selected by the network portal and having a fee-for-display contractual arrangement with the network portal.

14. The method of claim 13, wherein the displaying step further comprises:
selecting a number and type of service providers of the second service provider database based upon a fee-for-service contractual arrangement between the user and the Internet portal.

15. A method for a service provider to offer services through a network site link on a network portal comprising:
creating a service document representing services offered by the service provider in association with Internet portal keywords;
advertising the service document for inclusion into a database of service providers to be accessed by the network portal; and
permitting the network portal to display on the network portal a link to the service provider in association with a type-of-service keyword of the network portal.

16. The method of claim 15, further comprising:
receiving a service request from the user upon the user activating the type-of-service keyword on the network portal and then activating a link on the network portal to the service provider.

17. The method of claim 16, further comprising:
establishing a direct network communication link with the user; and
providing the requested services.

18. The method of claim 15, wherein the step of creating the service document step further comprises:
creating a list of keywords that represent the service provided and inserting the keyword list into the service document.

19. The method of claim 15, wherein the advertising step further comprises:
creating a communication connection between the service provider and the service provider database; and
insuring that the service document is up-to-date prior to its inclusion into the service provider database.

20. A method of operating a dynamic customizable network-centric software suite through a network portal comprising:
displaying on a network portal a listing of different categories of software applications;
upon activation of at least one software category, displaying on the network portal a link for each service provider offering that category-specific software application with the service providers retrieved from a first service provider database including a listing of service providers that self elect their inclusion into the database; and
selecting at least category-specific service provider that offers software services in response to each user selection of the service provider link.

21. The method of claim 20, further comprising:
upon activation of at least one software category, displaying on the internet portal a link for each service provider offering that category-specific software application with the service providers retrieved from a second service provider database including a listing of service providers that are exclusively selected by the network portal for inclusion into the second service provider database; and
selecting at least category-specific service provider offers software services in response to each user selection of the service provider link.

22. The method of claim 21, further comprising:
providing a payment function on the network portal to permit a user to make payment for and purchases of software applications; and
operating the customized network portal software suite with a login function to permit for a predetermined period of time.

23. A dynamic network portal system comprising:
a user interface;
at least one service provider;
a network portal viewable on the user interface and including a link to the at least one service provider wherein the network portal displays the service-provider links on a nonexclusive selection basis; and
a network communication link permitting communication between the user interface, the service provider and Internet portal.

24. The system of claim 23, further comprising:
a dynamic service provider database for maintaining a list of the service providers wherein the service providers self-elect their inclusion into the database by providing a predetermined set of information about the service provider for listing in the database.

25. The system of claim 24, wherein the network portal displays only service providers from the dynamic service provider database that match a set of predetermined user profile criteria.

26. The system of claim 25, wherein the network portal displays only service providers from the dynamic service provider database that match a predetermined set of services available to the user interface based on a fee-for-service contractual arrangement between the user interface and the Internet portal.

27. A dynamic service provider database system comprising
a service document identifying a service provider and a type of service provided; and
a service provider database for storing a plurality of service documents and for permitting display of the service provider represented by the service document on a network portal, wherein each service document is included in the database at the self-selection of the service provider.

28. The system of claim 27, wherein the service document further comprises:
at least one of the following categories of information: type-of-service keywords; service location; service billing; security models; and service-specific data.

29. A digital workshop portal system comprising:
a network-portal generated user screen displaying a plurality of utility functions, a summary function, and a payment function;
a link mechanism for displaying a link on the user screen to at least one service provider for each utility function wherein the displayed-service-provider links are selected from a nonexclusive database of service providers.

30. The portal system of claim 29, further comprising the utility functions being related to production of a brochure with a first utility function including a text function, a second utility function including a forms function, and a third utility function including a graphics function.

31. The portal system of claim 29, wherein the summary function further comprises displaying a list of service providers selected by the user and an associated fee-for-service arrangement between the user and the service provider selected.

32. The portal system of claim 29, wherein the payment function further includes a payment mechanism for the user interface to make payment to the service providers and upon activation of the payment function, services are ordered from the selected service providers.

33. The portal of claim 29, wherein the utility functions further comprise at least one of a database software application, a word processor software application, a spreadsheet software application, and a publishing software application.

34. The portal system of claim 29, further comprising a login function to permit a user through user interface to access selected service providers periodically over a predetermined period of time in accordance with a predetermined fee-for-service arrangement between the user and the service providers.

35. A computer-readable medium having computer-executable instructions for performing a method of constructing a network portal, the method comprising:
accessing a first service provider database that includes a listing of service providers that have self-selected their inclusion into the first service provider database; and
displaying keyword-service links on the network portal in association with the service providers from the first service provider database.
